(19) United States
(12) Patent Application Publication
(10) Pub. No.: US 2003/0023642 A1
(43) Pub. Date: Jan. 30, 2003

(54) Method and system for marking writings online

(76) Inventor: James S-B Spragins, Lutherville, MD (US)

Correspondence Address: LARRY J. GUFFEY, WORLD TRADE CENER - SUITE 1800, 401 EAST PRATT STREET, BALTIMORE, MD, 21202, US

(21) Appl. No.: 09/917,995

(22) Filed: Jul. 30, 2001

(51) Int. Cl. G06F 17/24

(52) U.S. Cl. 707/530; 707/501.1

(57) ABSTRACT

The present invention is a method and system for inserting editorial markings and comments into an electronic writing, while compiling an assortment of statistics on the inserted markings and comments. Such a method comprises the steps of: (a) developing a set of editorial markings, (b) providing means for displaying said markings on a video display, (c) selecting a marking for insertion into the writing, (d) saving information pertaining to said inserted markings so as to establish a database that documents the use of the inserted markings, (e) compiling summary statistics for the saved markings, (f) filtering the saved markings so that only a specified portion of such markings remain in the writing when it is returned to its writer, and (g) hyperlinking the inserted markings to specified websites having information pertaining to the inserted markings.

### BACKGROUND OF THE INVENTION

1. Field of the Invention

The present invention relates to education and the data processing task of editing electronic texts. More particularly, this invention relates to a system and method for evaluating and providing editorial feedback on an electronic writing.

2. Description of the Related Art

For many years, those English teachers who teach compositional writing have spent considerable amounts of their work-time in the task of reading, marking and grading the essays written by their students. As a means of providing their students with as much constructive feedback as possible, this marking process often involves teachers inserting their editorial comments into the margins of their students' essays—an always time-consuming and often a somewhat repetitive task as a result of the similarities in the editorial comments.

For electronic writings or those composed on computers using word processing software, compositional writing students can usually use their software's spelling and grammar checkers in an attempt to avoid such errors in their writings. While using such checkers may make their teachers' editorial marking and grading tasks somewhat easier, such checkers do not do the comprehensive job of evaluating usage and punctuation than an experienced teacher can provide. For providing feedback on how student essays handle matters such as developing ideas cogently, organizing them logically and connecting them with clear transitions, compositional writing teachers still must resort to inserting an assortment of editorial comments into the margins of such writings.

There appears to have been few, if any, attempts to address the compositional writing teachers overall task of “reading, editorially marking and grading” student essays. Instead, previous inventive efforts in this area appear to have been directed only to the grading aspects of this task. For example, U.S. Pat. No. 6,181,909 discloses a system and method for automating the grading of essays. It accomplishes this by parsing the essay into a syntactic representation of the essay and then grading this representation using various specified heuristics. This invention makes no attempt to provide a student writer with any editorial feedback regarding specific parts of an essay.

U.S. Pat. No. 5,987,302 discloses an online essay evaluation system. In general, this system is directed towards many topics of the evaluation process other than providing student feedback (e.g., administrative matters, such as billing and scheduling of essay readers). The only feedback that this system makes available for students consists of generalized rubrics that have been developed for use with essays that fall within specified scoring ranges. Feedback on specific parts of the essay are not provided, and no attempt is made to return to the student an essay with any editorial markings.

U.S. Pat. No. 5,576,955 discloses a method and apparatus for proofreading in a computer system. However, it is directed toward use by individual essay writers, rather than their teachers. Similar to a spell checker for use by a writer in identifying and simultaneously correcting spelling errors in draft versions of their electronic writings, this proofreading apparatus attempts to identify and simultaneously facilitate corrections for a wider range of compositional writing errors (e.g., spelling, punctuation, grammar, usage, broken words, doubled words and capitalization).

Despite the prior art, there exists a continuing need for new and improved methods and apparatus for reducing the editorial workloads of compositional writing teachers. The present invention substantially fulfills this need.

### SUMMARY OF THE INVENTION

The present invention is generally directed to satisfying the needs set forth above and overcoming the limitations and problems identified with prior systems and methods used by compositional writing teachers in editorially marking and grading their students' essays.

In accordance with one preferred embodiment, the present invention takes the form of a method for marking an electronic writing created with a specified word processing software and which is displayable with this software on a video display of a computer system. This method comprises the steps of: (a) developing a set of editorial markings for a writing that, when inserted into the writing, communicates information, regarding the portion of the writing in proximity to the marking's insertion point, chosen from the group consisting of information on the writing's punctuation, capitalization, italicization, grammar, word usage, content or form, (b) providing means for displaying the set of markings on the video display, (c) selecting, from the set of editorial markings, a marking to be inserted into the writing in order to give its writer feedback on the portion of the writing in proximity to the marking's insertion point, (d) inserting the markings into the electronic writing at specified locations within the writing, (e) saving the inserted markings used in marking the writing so as to establish a database that documents the use of the inserted markings for the writing, and (f) compiling summary statistics for the saved markings that communicate information selected from the group consisting of information pertaining to: (i) specified skills that the writer would need to focus upon in order to improve the writer's writing skills, (ii) for a series of the writings by the same writer, the writer's progress towards improvement in those areas identified by the markings as needing improvement, (iii) for a collection of writings by a group of writers who are being instructed as a group, the group's general areas denoted as needing improvement by the markings inserted into the collection of writings, and (iv) for a series of writings by the group, the group's progress towards improvement in those areas identified as needing improvement by the markings inserted into the series of writings.

According to another preferred embodiment, this method for marking an electronic writing further includes the steps of: (g) developing a means for filtering the saved markings so that only a specified portion of such markings remain in the writing when it is returned to its writer, and (h) hyperlinking the inserted markings to specified websites, on a network of linked computers, having information chosen from the group consisting of detailed explanations of the markings and exercises that one can undertake in order to strengthen those writing skills which are denoted by the markings as representing areas in which the writer needs improvement.

A preferred means for implementing the step of selecting a marking to be inserted into the writing comprises the development of a toolbar that is shown on the video display as being situated adjacent to the operating screen of the word processing software. This toolbar contains a group of icons, each of which represents one of the set of editorial markings.

In accordance with another preferred embodiment, the present invention takes the form of a computer program product for marking an electronic writing and which is on a computer readable memory executable by a computer system that operates a specified word processing software. This product comprises: (a) a set of editorial markings for an electronic writing that, when inserted into the writing, communicates information, regarding the portion of the writing in proximity to the marking's insertion point, chosen from the group consisting of information on the writing's punctuation, capitalization, italicization, grammar, word usage, content or form, (b) means for displaying the set of markings on the video display, (c) means for selecting, from the set of editorial markings, a marking to be inserted into the writing in order to give its writer feedback on the portion of the writing in proximity to the marking's insertion point, (d) means for inserting the markings into the electronic writing at specified locations within the writing, (e) means for saving the inserted markings used in marking the writing so as to establish a database that documents the use of the inserted markings for the writing, (f) means for compiling summary statistics for the saved markings that communicate information selected from the group consisting of information pertaining to: (i) specified skills that the writer would need to focus upon in order to improve the writer's writing skills, (ii) for a series of the writings by the same writer, the writer's progress towards improvement in those areas identified by the markings as needing improvement, (iii) for a collection of writings by a group of writers who are being instructed as a group, the group's general areas denoted as needing improvement by the markings inserted into the collection of writings, and (iv) for a series of writings by the group, the group's progress towards improvement in those areas identified as needing improvement by the markings inserted into the series of writings, (g) means for filtering the saved markings so that only a specified portion of such markings remain in the writing when it is returned to its writer, and (h) means for hyperlinking the inserted markings to specified websites, on a network of linked computers, having information chosen from the group consisting of detailed explanations of the markings and exercises that one can undertake in order to strengthen those writing skills which are denoted by the markings as representing areas in which the writer needs improvement.

The present invention is seen to overcome the limitations of the prior art. It is therefore an object of the present invention to provide an improved method and system for editorially marking an electronic writing.

It is another object of the present invention to reduce the time that compositional writing teachers spend in the task of reading, marking and grading the essays written by their students.

It is a yet another object of the present invention to provide a method and system that allows compositional writing teachers to effectively compile statistics on the types of mistakes that their students are making, either as a group or in a series of writings by an individual student.

These and other objects and advantages of the present invention will become readily apparent as the invention is better understood by reference to the accompanying drawings and the detailed description that follows.

### BRIEF DESCRIPTION OF THE DRAWINGS

FIG. 1 illustrates the toolbars that are used by the computer program embodiment of the present invention.

FIGS. 2(a)-2(d) illustrate the marking icons and associated standard comments that are used by the computer program embodiment of the present invention.

FIG. 3 illustrates the “text” and “dialog” buttons that are used by the computer program embodiment of the present invention.

FIGS. 4(a) and 4(b) illustrate the “text on” and “dialog on” mode for inserting markings and comments using the computer program embodiment of the present invention.

FIGS. 5(a) and 5(b) illustrate the “text off” and “dialog on” mode for inserting markings and comments using the computer program embodiment of the present invention.

FIG. 6 illustrates the “text off” and “dialog of” mode for inserting markings and comments using the computer program embodiment of the present invention.

FIG. 7 illustrates a “puff down menu” means for inserting markings and comments using the computer program embodiment of the present invention.

FIG. 8 illustrates a keyboarding means, using an “Annotate By Code” key, for inserting markings and comments using the computer program embodiment of the present invention.

FIG. 9(a) illustrates a student's composition that has been thoroughly marked using the computer program of the present invention.

FIG. 9(b) illustrates the means for enabling a teacher to filter the markings that will appear in the version of the marked essay that is returned to the student.

FIG. 9(c) illustrates the filtered version of a portion of the marked essay seen in FIG. 9(a).

FIGS. 10(a) and 10(b) illustrate how the present invention's inserted markings may be hyperlinked to websites containing information pertaining to the inserted markings.

FIG. 11 illustrates the means for displaying some of the statistics that may be compiled for the inserted markings of the present invention.

FIG. 12 illustrates a respresentative computer system on which the present invention can be run.

FIG. 13 shows a block diagram of a representative computer in which the present invention can be implemented.

### DESCRIPTION OF THE PREFERRED EMBODIMENT

For purposes of explanation and not limitation, specific details are set forth below, such as computer screen layouts and designs, in order to provide a thorough understanding of the present invention. However, it will be apparent to one skilled in the art that the present invention may be practiced in other embodiments that depart from these specific details. In other instances, detailed descriptions of well known, software writing methods, etc. are omitted so as not to obscure the description of the present invention with unnecessary detail.

Referring now to the drawings wherein are shown preferred embodiments and wherein like reference numerals designate like elements throughout, there is shown in these drawings the various aspects of a method, system and computer program for marking an electronic writing. For purposes of illustration, the electronic writing in these drawings has been composed using Microsoft Word 2000 software. However, it will be recognized that the elements and steps of the present invention could have been just as easily illustrated by electing to use an electronic writing composed with any of the other comparable pieces of word processing software.

The present invention in the form of a computer program for editorially marking an electronic writing consists of: a set 10 of editorial markings for insertion into the writing, a means for selecting 12 a specific marking 14 for insertion into the writing, a means for saving 16 the inserted markings, a means for compiling 18 summary statistics 20 for the saved markings, a means for filtering 22 the saved markings so that only a specified portion of such markings remain in the writing when its marked version is returned to its writer, and a means for hyperlinking 24 the inserted markings to specified websites that explain the markings and contain exercises that one can undertake in order to strengthen those writing skills which are denoted by the markings as representing areas needing improvement.

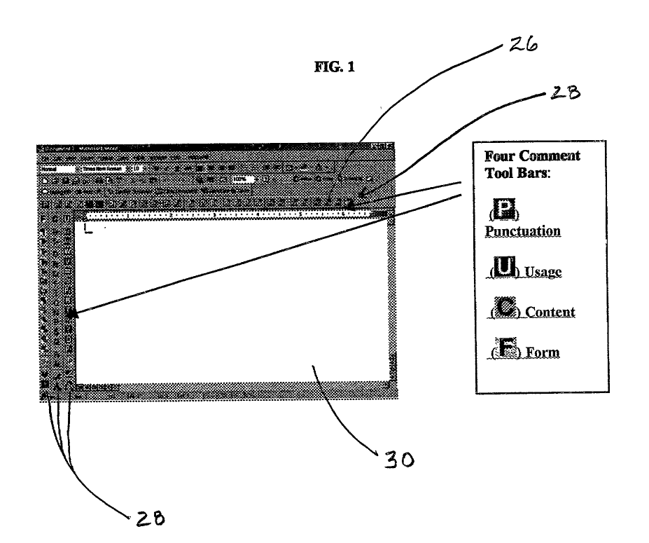

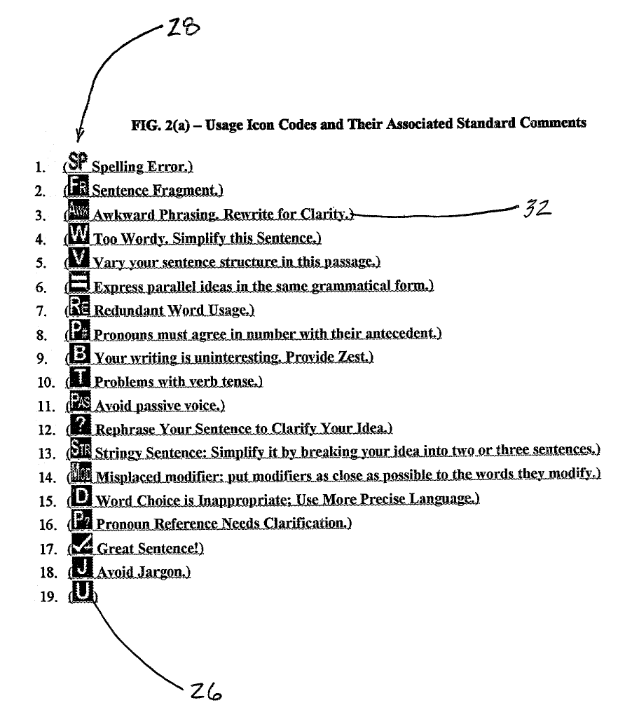

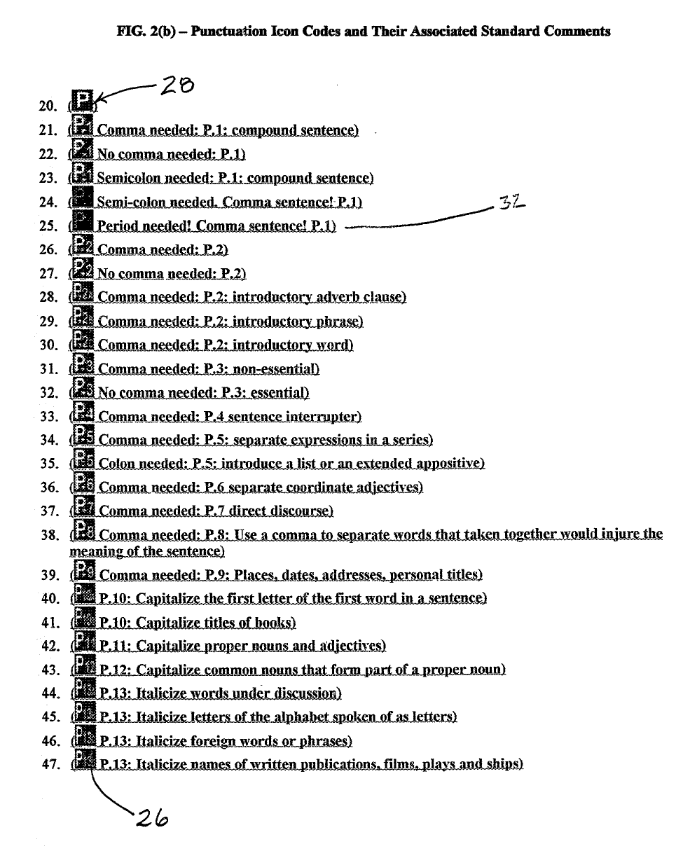

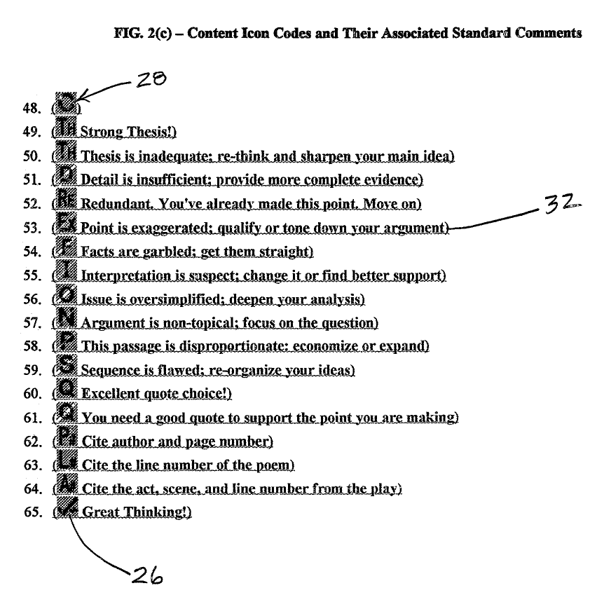

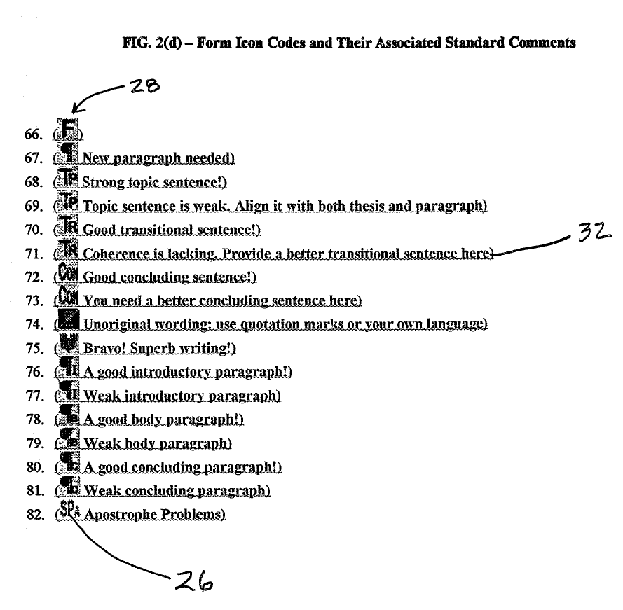

FIGS. 1 through 11 provide a view of the various computer screens that a user of this computer program might encounter while using it. FIG. 1 illustrates how the means for selecting 12 a marking for insertion into the writing is accomplished by having one click on various icons 26 that represent the individual markings and which are presented in toolbars 28 that are displayed adjacent to the word processing software's main window 30. In this example, four editing toolbars have been created, with the icons of each being used for either the insertion of punctuation, usage, content or form markings. With each of these markings there is also associated a standard, explanatory comment 32 that may or may not be inserted, along with the marking, in a student's essay. For example, for a “W” icon that implies a “wordy” sentence, the standard comment might be “too wordy, simplify this sentence.” See FIGS. 2(a)-2(d) for a listing of these icons and their associated standard comments.

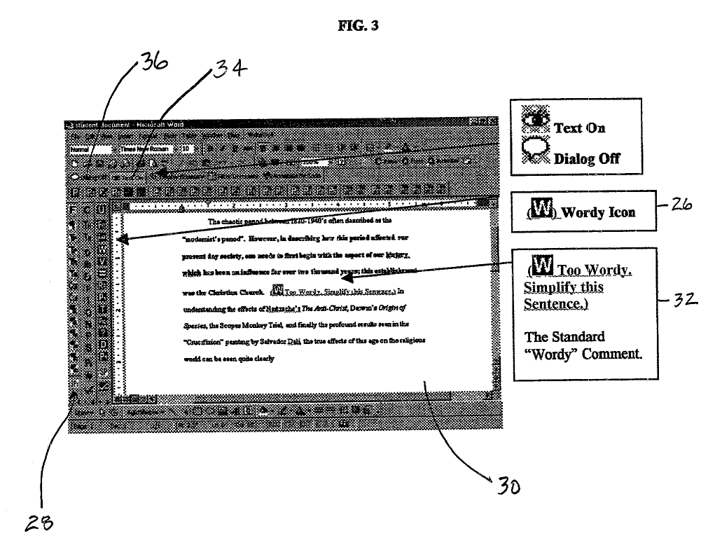

By clicking on one of these icons 26, a teacher can insert a marking and possibly also a comment directly into a student's essay at the current location of the cursor in the essay. Such markings and comments can take one of several forms. FIG. 3 shows “text” 34 and “dialog” 36 buttons that have been created in order to provide variety in the form of the inserted markings or comments. These buttons are part of an additional marking toolbar that has been added below the standard toolbars of the word processing software. By clicking on the “text on” and “dialog off” buttons, the teacher is able to insert a selected marking and its standard comment.

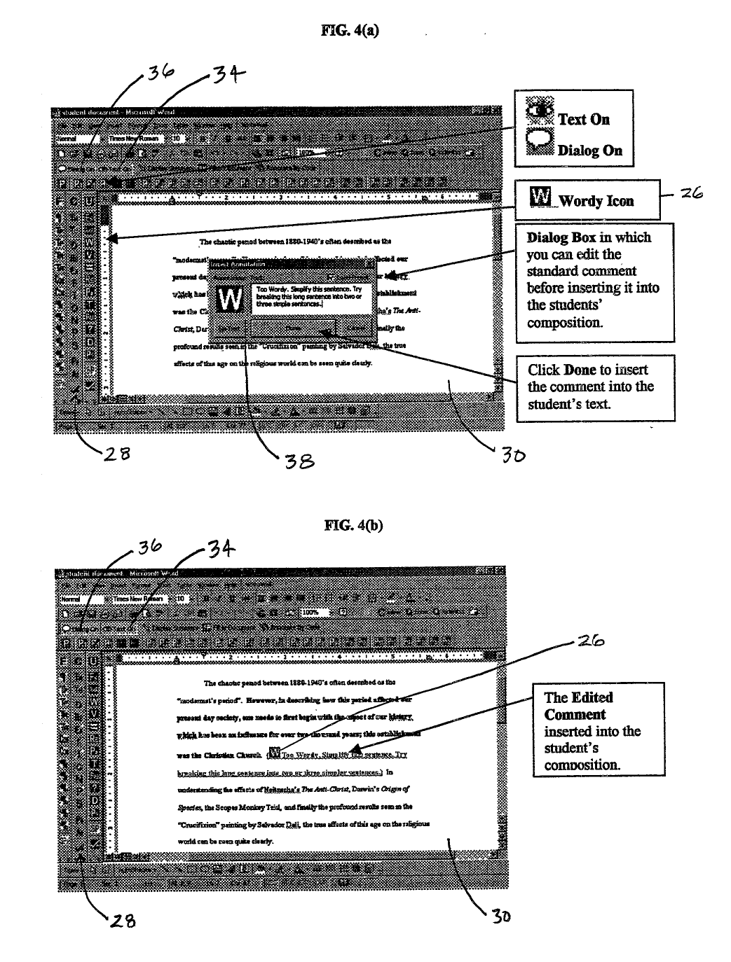

As shown in FIGS. 4(a) and 4(b), by staying in the “text on” mode, and with the “dialog” button now placed in the “dialog on” mode, the standard comment that is inserted with the marking can be edited and elaborated upon. This is accomplished by having a dialog box 38 appear when any marking is selected for insertion. This box which initially contains the standard comment can be easily edited.

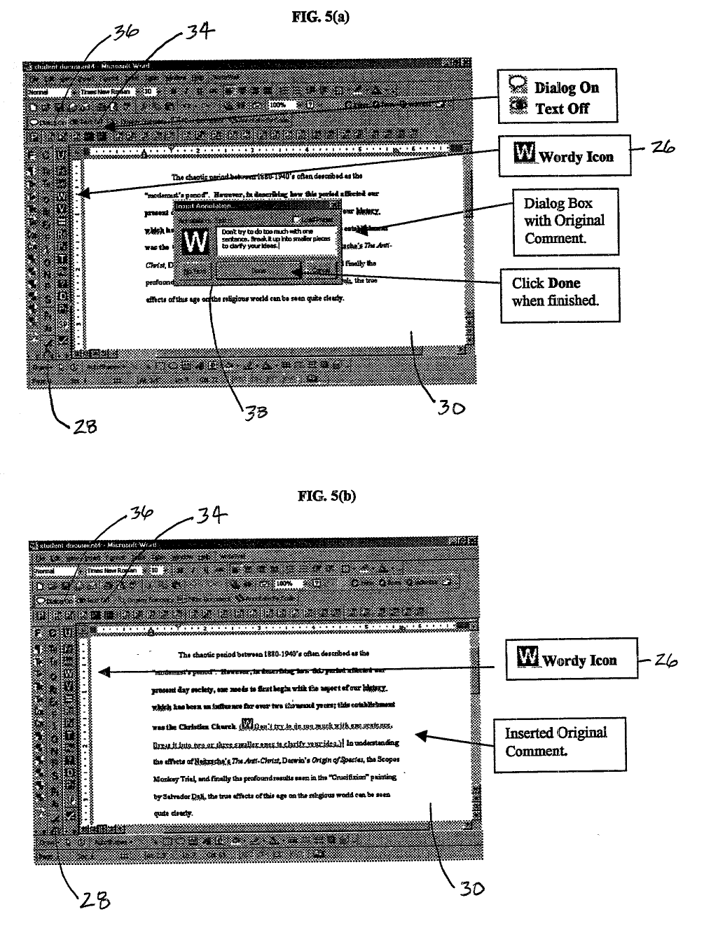

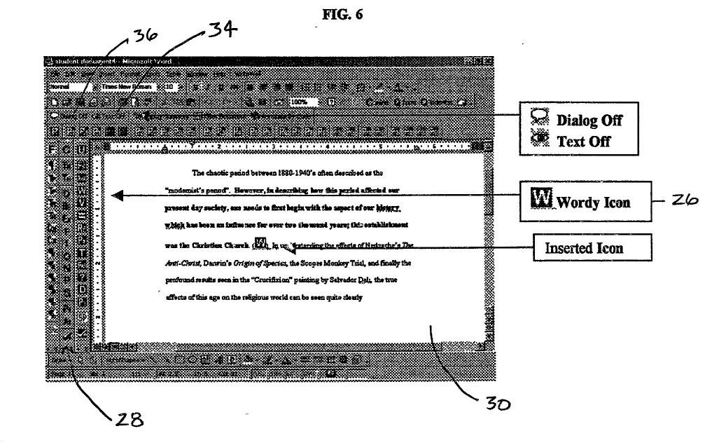

FIGS. 5(a) and 5(b) illustrate that in the “text off” and “dialog on” mode, a dialog box 38 again appears when an icon is selected. However, the dialog box is initially vacant so that a totally original comment may be inserted with the marking. FIG. 6 represents the situation in the “text off” and “dialog of” mode when only a marking is inserted.

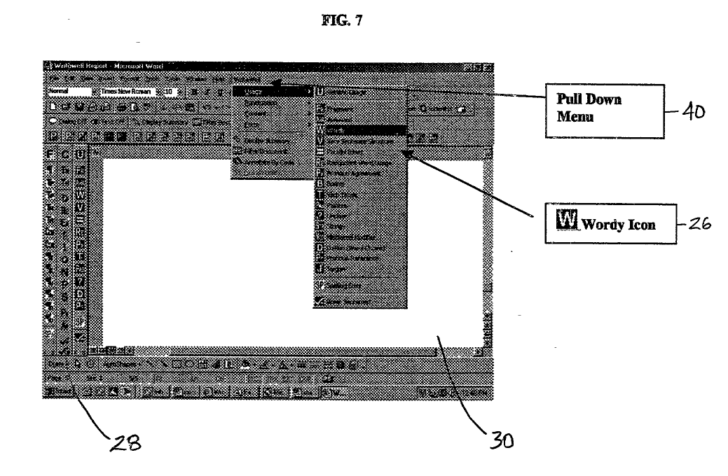

As shown in FIG. 7, when a user of this computer program needs a reminder about which comment is represented by a specific icon, they can quickly consult a pull down menu 40. All the icons of the various toolbars and their standard comments are accessible from these menus 40. Comments can also be inserted from the pull down menus. Additionally, by placing the cursor over an icon on the toolbar, the standard comment associated with this comment and its code number are shown in a dialog box that appears on a user's computer screen.

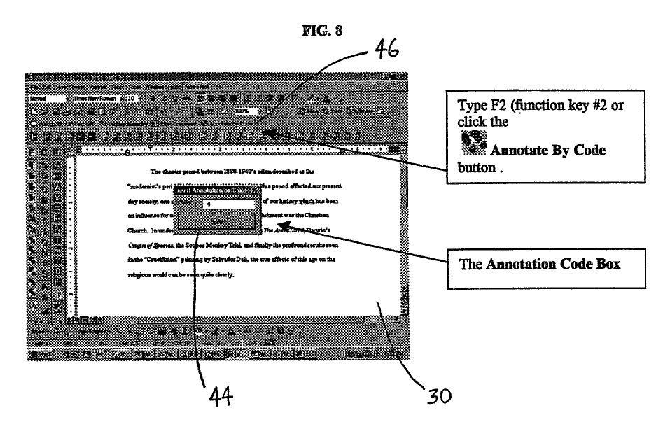

Those who have good keyboarding skills may prefer to insert their markings and comments without using the icons and utilizing the click and point method. FIG. 8 illustrates that this is accomplished by striking the keyboard's F2 key 42 which causes a dialog box 44 to appear that calls for the user to insert in the box the appropriate number of the marking to be inserted into the student's essay. This function can also be accomplished by clicking on an “Annotate By Code” button 46 that has been added to the word processor's additional marking toolbar.

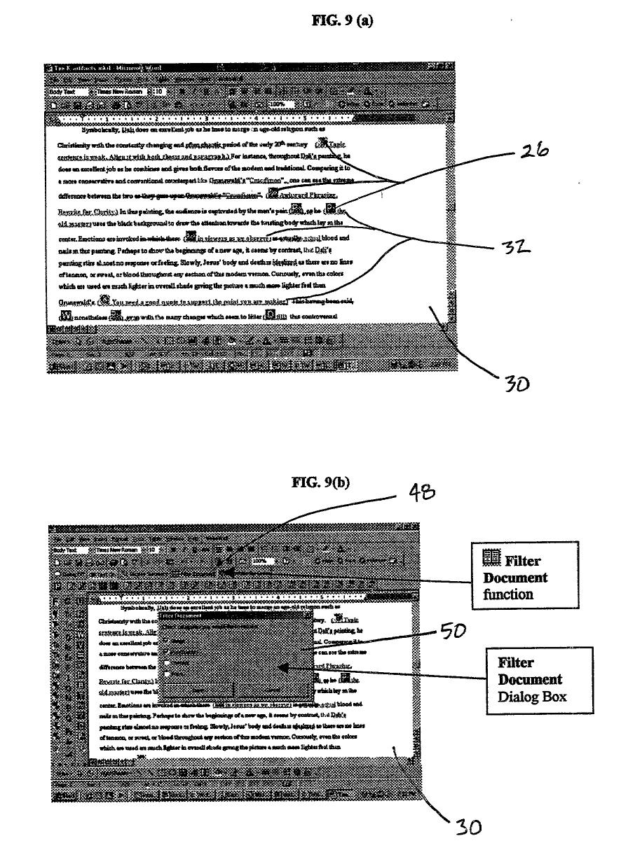

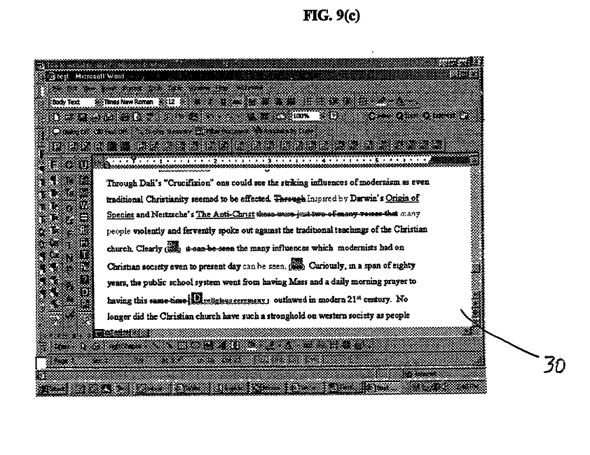

When a student's composition is thoroughly marked, it can often display many of these editorial markings and can appear quite threatening to a student's confidence in their writing skills. See FIG. 9(a).

Since no student wants to see an essay that has been covered with inserted markings and comments indicating problems in his or her writing, it has proven useful to provide the present invention with the capability to allow a user to filter the inserted markings before a marked essay is actually returned to a student. For example, assume that a student has struggled with his or her “usage” and “punctuation” in a particular essay or series of essays. In this situation, a teacher might want the student to work on these areas before addressing “content” and “form” issues. To encourage this, the teacher has the ability to filter a marked essay so that only the “usage” and “punctuation” markings appear in the version of the marked essay that is returned to the student.

To accomplish this filtering process, the present program has been provided with a “Filter Document” button 48. Upon clicking on this button, a “Filtering Dialog Box” 50 is opened that enables a teacher to select the markings and comments that the teacher wishes to be shown on the version of the marked essay that is to be returned to the student. See FIG. 9(b). All other markings are filtered, as shown in FIG. 9(c).

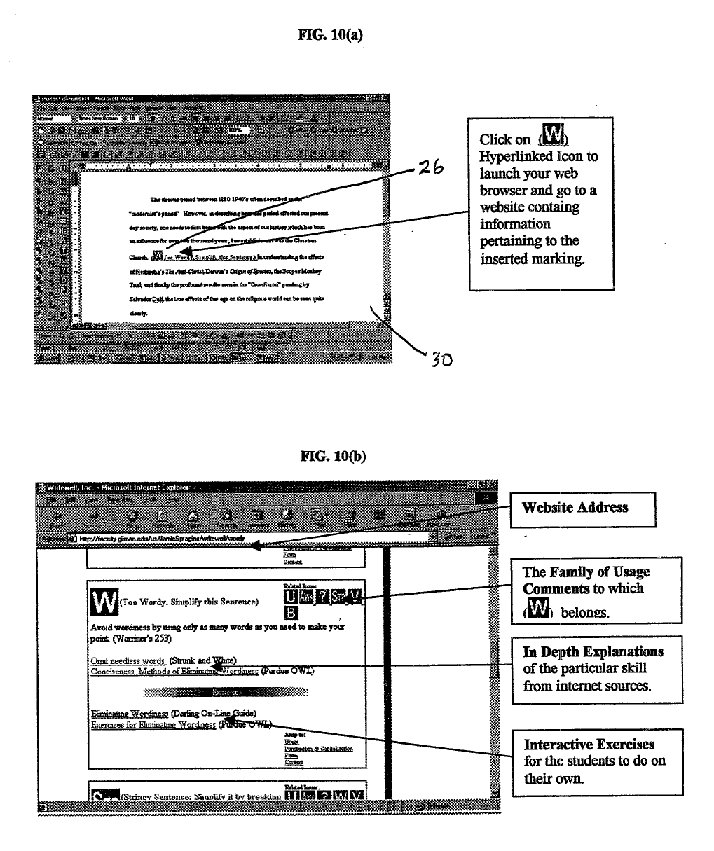

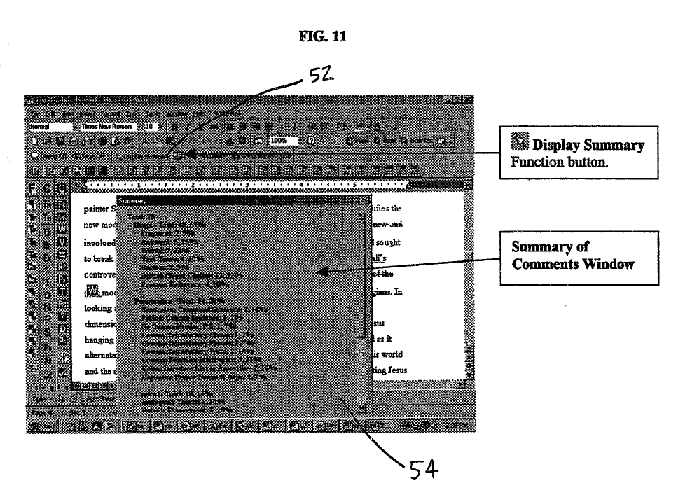

As a means of increasing the instructional value of this computer program, the inserted marking may be hyperlinked to various websites on a network of linked computers, such as the Internet, that contain an assortment of information pertaining to the marking or its associated comments. FIGS. 10(a) and 10(b) illustrate the use of such hyperlinked, inserted markings. In this embodiment, the code for this computer program has been written so that when one clicks on an inserted icon the computer's browser is automatically launched and one is sent to a specific website having information or instructional exercises pertaining to the marking or its associated comment. Such a website can also route students to other websites having interactive games and exercises where they can use such materials to improve those of their writing skills which are being addressed by the inserted marking or comment.

As an aid to assist a teacher in assessing the progress of an individual writing student or class of students, this computer program embodiment of the present invention has been provided with code that allows various types of statistics to be computed for the markings being inserted. This is accomplished by creating a database which documents the insertion of the various editorial comments and comments. Within this database, various groups of essays may be comparatively reviewed. For example, a teacher may elect several essays written during an initial period of time by an individual student and then compute the percentage of occurrences of each of the inserted markings. These percentages can be compared to similar statistics that are compiled for a comparable number of essays written by this same student during a later period of time. Such a comparison will reveal if the student's initial writing areas needing improvement are actually improving, and what, if any, new areas of the student's writing are being indicated by the later inserted marking as needing improvement.

The technique for making these statistics readily available to the teacher is shown in FIG. 11. By clicking on a “Display Summary” button 52, the insertion percentages for the markings are displayed in a “Summary” window 54 that is automatically opened by the program. Additionally, the code for this computer program can be written such that a particular point value is assigned to each icon. By summing these point values for the various markings placed on a student's paper, this computer program can effectively provide the teacher with a “grade” for a marked paper that is a measure of the teacher's assessment of the overall quality of the writing.

The present invention also possesses the ability to combine these statistics for inserted marking with information from other databases in order to foster a wide variety of studies of student writings skills and habits. For example, combining these statistics for inserted markings with demographic data for the student writers may allow for some statistically-based conclusions to be drawn regarding the types of compositional writing mistakes most commonly seen in groups of students having specified, similar demographic backgrounds.

The computer program of the invention may be run on a variety of computers or collection of computers under a number of different operating systems. The computer could be, for example, a personal computer, a mini computer, mainframe computer or a computer running in a distributed network of other computers.

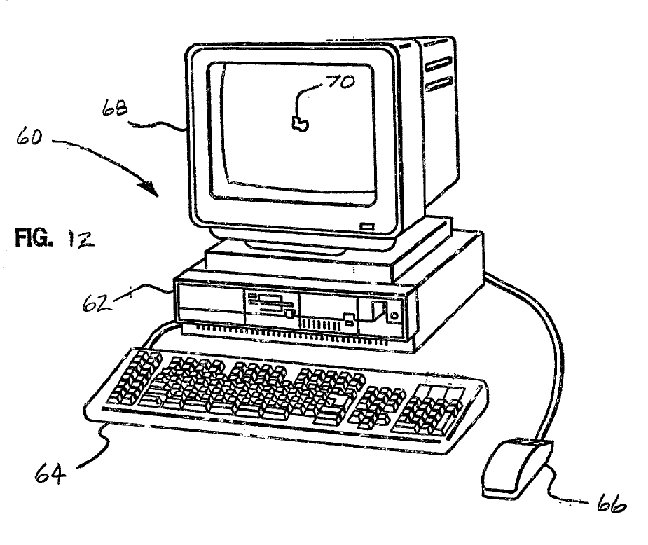

In FIG. 12, a computer 60, comprising a system unit 62, a keyboard 64, a mouse 66 and a video display 68 are depicted. The screen 70 of video display device 68 is used to present a graphical user interface (GUI). The graphical user interface supported by the operating system allows the user to use a point and click method of input.

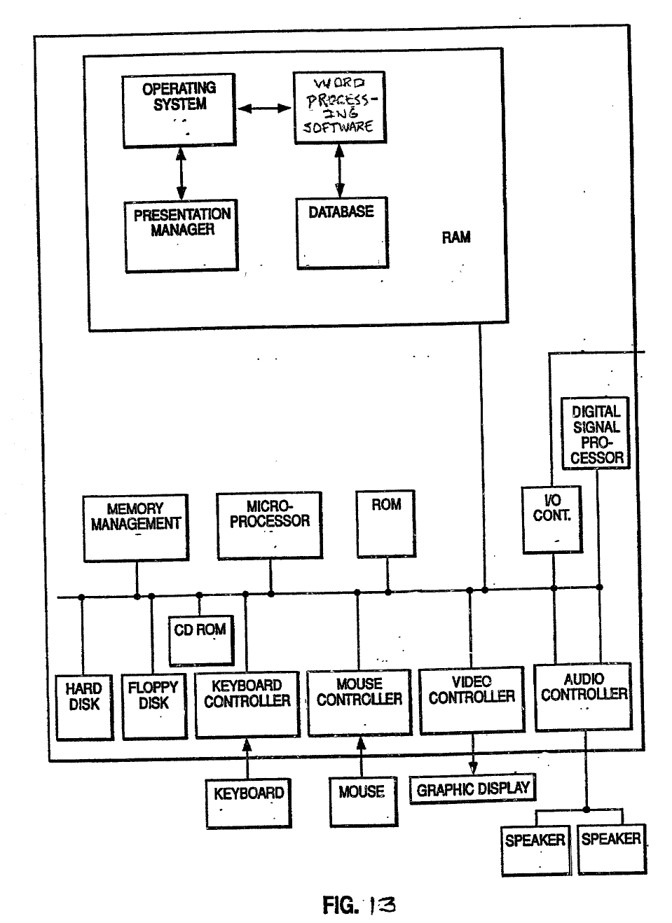

FIG. 13 shows a block diagram of a representative computer in which the present invention is implemented. Such a computer includes a system bus or plurality of system buses to which various components are coupled and by which communication between the various components is accomplished. The microprocessor or central processing unit (CPU) is connected to the system bus and is supported by read only memory (ROM) and random access memory (RAM) also connected to system bus. The ROM contains among other code the Basic Input-Output system (BIOS) which controls basic hardware operations such as the interaction and the disk drives and the keyboard. The RAM is the main memory into which the operating system and application programs are loaded. The memory management chip is connected to the system bus and controls direct memory access operations including, passing data between the RAM and hard disk drive and floppy disk drive. The CD ROM, also coupled to the system bus, is used to store a large amount of data, e.g., a multimedia program or large database.

Also connected to this system bus are various I/O controllers: the keyboard controller, the mouse controller, the video controller, and the audio controller. The keyboard controller provides the hardware interface for the keyboard, the mouse controller provides the hardware interface for the mouse (or other point and click device), the video controller is the hardware interface for the video display, and the audio controller is the hardware interface for any multimedia speakers. An I/O controller enables communication over a network to other similarly configured data processing systems.

The computer program embodiment of the present invention may exist as a set of instructions in a code module resident in the RAM. Until required by the computer system, the set of instructions may be stored in another computer memory, for example, in the hard disk drive, in an optical disk for eventual use in the CD ROM or in a floppy disk for eventual use in the floppy disk drive. As shown in FIG. 13, the operating system and word processing software are resident in RAM. Since the various methods of such operating system and word processing software are well known to the art, these methods will not be discussed herein in any detail.

The foregoing descriptions of the invention have been presented for purposes of illustration and description. Further, the description is not intended to limit the invention to the form disclosed herein. Consequently, variations and modifications commensurate with the above teachings, and combined with the skill or knowledge in the relevant art are within the scope of the present invention.

The preferred embodiments described herein are further intended to explain the best mode known of practicing the invention and to enable others skilled in the art to utilize the invention in various embodiments and with various modifications required by their particular applications or uses of the invention. It is intended that the appended claims be construed to include alternate embodiments to the extent permitted by the current art.

I claim:

1. A method for providing feedback on an electronic writing created with a word processing software and wherein said writing being displayable using said software on a video display of a computer system, said method comprising the steps of:
developing a set of editorial markings that may be inserted into said writing,
selecting from said set of editorial markings a marking to be inserted into said writing,
inserting said marking into said electronic writing, and
saving information pertaining to said inserted marking in said computer system so as to establish a database that documents the use of said markings in said writing.

2. A method for providing feedback on an electronic writing as recited in claim 1, further comprising the step of:
compiling summary statistics for said saved markings that communicate information pertaining to the use of said markings in said writing.

3. A method for providing feedback on an electronic writing as recited in claim 2, further comprising the step of:
filtering said inserted markings so that only a specified portion of such markings remain in said writing when it is returned to its writer.

4. A method for providing feedback on an electronic writing as recited in claim 1, further comprising the step of:
hyperlinking said inserted marking to a website that exists on a network of linked computers.

5. A method for providing feedback on an electronic writing as recited in claim 2, further comprising the step of:
hyperlinking said inserted marking to a website that exists on a network of linked computers.

6. A method for providing feedback on an electronic writing as recited in claim 3, further comprising the step of:
hyperlinking said inserted marking to a website that exists on a network of linked computers.

7. A method for providing feedback on an electronic writing as recited in claim 1, wherein:
said inserted marking communicates information, regarding a portion of said writing in proximity to said marking's insertion point, chosen from the group consisting of information on the writing's punctuation, capitalization, italicization, grammar, word usage, content or form.

8. A method for providing feedback on an electronic writing as recited in claim 2, wherein:
said compiled summary statistics communicate information selected from the group consisting of information pertaining to: (a) specified skills that said writer would need to focus upon in order to improve said writer's writing skills, (b) for a series of said writings by the same writer, said writer's progress towards improvement in those areas identified by said inserted markings as needing improvement, (c) for a collection of writings by a group of writers who are being instructed as a group, said group's general areas denoted by said inserted markings as needing improvement, and (d) for a series of writings by said group, said group's progress towards improvement in those areas identified by said inserted markings as needing improvement.

9. A method for providing feedback on an electronic writing as recited in claim 4, wherein:
said website having information chosen from the group consisting of detailed explanations of said markings and exercises that one can undertake in order to strengthen those writing skills which are denoted by said inserted markings as representing areas in which said writer needs improvement.

10. A method for providing feedback on an electronic writing as recited in claim 1, wherein:
said inserted marking having an associated editorial comment that is insertable in said writing.

11. A computer program product in a computable readable memory for providing feedback on an electronic writing created with a word processing software and wherein said writing being displayable using said software on a video display of a computer system, said computer program product comprising:
a set of editorial markings that may be inserted into said writing,
means for displaying said set of markings on said video display,
means for selecting from said set of editorial markings a marking to be inserted into said writing,
means for inserting said marking into said electronic writing, and
means for saving information pertaining to said inserted marking in said computer system so as to establish a database that documents the use of said markings in said writing.

12. A computer program product for providing feedback on an electronic writing as recited in claim 11, further comprising:
means for compiling summary statistics for said saved markings that communicate information pertaining to the use of said markings in said writing.

13. A computer program product for providing feedback on an electronic writing as recited in claim 12, further comprising:
means for filtering said inserted markings so that only a specified portion of such markings remain in said writing when it is returned to its writer.

14. A computer program product for providing feedback on an electronic writing as recited in claim 11, further comprising:
means for hyperlinking said inserted marking to a website that exists on a network of linked computers.

15. A computer program product for providing feedback on an electronic writing as recited in claim 12, further comprising:
means for hyperlinking said inserted marking to a website that exists on a network of linked computers.

16. A computer program product for providing feedback on an electronic writing as recited in claim 13, further comprising:
means for hyperlinking said inserted marking to a website that exists on a network of linked computers.

17. A computer program product for providing feedback on an electronic writing as recited in claim 11, wherein:
said inserted marking communicates information, regarding a portion of said writing in proximity to said marking's insertion point, chosen from the group consisting of information on the writing's punctuation, capitalization, italicization, grammar, word usage, content or form.

18. A computer program product for providing feedback on an electronic writing as recited in claim 12, wherein:
said compiled summary statistics communicate information selected from the group consisting of information pertaining to: (a) specified skills that said writer would need to focus upon in order to improve said writer's writing skills, (b) for a series of said writings by the same writer, said writer's progress towards improvement in those areas identified by said inserted markings as needing improvement, (c) for a collection of writings by a group of writers who are being instructed as a group, said group's general areas denoted by said inserted markings as needing improvement, and (d) for a series of writings by said group, said group's progress towards improvement in those areas identified by said inserted markings as needing improvement.

19. A computer program product for providing feedback on an electronic writing as recited in claim 14, wherein:
said website having information chosen from the group consisting of detailed explanations of said markings and exercises that one can undertake in order to strengthen those writing skills which are denoted by said inserted markings as representing areas in which said writer needs improvement.

20. A computer program product for providing feedback on an electronic writing as recited in claim 11, wherein:
said inserted marking having an associated editorial comment that is insertable in said writing.

21. A system including processor, memory, video display and input device for providing feedback on an electronic writing created with a word processing software and wherein said writing being displayable using said software on said a video display, comprising:
a set of editorial markings that may be inserted into said writing,
means for displaying said set of markings on said video display,
means for selecting from said set of editorial markings a marking to be inserted into said writing,
means for inserting said marking into said electronic writing, and
means for saving information pertaining to said inserted marking in said computer system so as to establish a database that documents the use of said markings in said writing.

22. A system providing feedback on an electronic writing as recited in claim 21, further comprising:
means for compiling summary statistics for said saved markings that communicate information pertaining to the use of said markings in said writing.

23. A system for providing feedback on an electronic writing as recited in claim 22, further comprising:
means for filtering said inserted markings so that only a specified portion of such markings remain in said writing when it is returned to its writer.

24. A system for providing feedback on an electronic writing as recited in claim 21, further comprising:
means for hyperlinking said inserted marking to a website that exists on a network of linked computers.

25. A system for providing feedback on an electronic writing as recited in claim 22, further comprising:
means for hyperlinking said inserted marking to a website that exists on a network of linked computers.

26. A system for providing feedback on an electronic writing as recited in claim 23, further comprising:
means for hyperlinking said inserted marking to a website that exists on a network of linked computers.

27. A system for providing feedback on an electronic writing as recited in claim 21, wherein:
said inserted marking communicates information, regarding a portion of said writing in proximity to said marking's insertion point, chosen from the group consisting of information on the writing's punctuation, capitalization, italicization, grammar, word usage, content or form.

28. A system for providing feedback on an electronic writing as recited in claim 22, wherein:
said compiled summary statistics communicate information selected from the group consisting of information pertaining to: (a) specified skills that said writer would need to focus upon in order to improve said writer's writing skills, (b) for a series of said writings by the same writer, said writer's progress towards improvement in those areas identified by said inserted markings as needing improvement, (c) for a collection of writings by a group of writers who are being instructed as a group, said group's general areas denoted by said inserted markings as needing improvement, and (d) for a series of writings by said group, said group's progress towards improvement in those areas identified by said inserted markings as needing improvement.

29. A system for providing feedback on an electronic writing as recited in claim 24, wherein:
said website having information chosen from the group consisting of detailed explanations of said markings and exercises that one can undertake in order to strengthen those writing skills which are denoted by said inserted markings as representing areas in which said writer needs improvement.

30. A system for providing feedback on an electronic writing as recited in claim 21, wherein:
said inserted marking having an associated editorial comment that is insertable in said writing.
